(19) United States
(12) Patent Application Publication
(10) Pub. No.: US 2011/0262163 A1
(43) Pub. Date: Oct. 27, 2011

(54) IMAGE TRANSFER POSITION ADJUSTMENT

(75) Inventor: Susumu Koizumi, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/083,273

(22) Filed: Apr. 8, 2011

Related U.S. Application Data
(60) Provisional application No. 61/326,545, filed on Apr. 21, 2010.

(51) Int. Cl. G03G 15/16

(52) U.S. Cl. 399/66

(57) ABSTRACT

According to one embodiment, a conveying mechanism including a visualizing agent image carrying mechanism configured to move visualizing agent image, which moves to sheet, to a moving position to sheet, a conveying mechanism configured to move sheet to the moving position where visualizing agent image moves to sheet, a visualizing agent image detector configured to detect the visualizing agent image moved by the visualizing agent image carrying mechanism, a media detector configured to detect passage of sheet to be capable of calculating moving speed of sheet, and a setting unit configured to set, if size of a shift of relative positions of visualizing agent image and sheet exceeds a tolerance, at least one of speed of the visualizing agent image carrying mechanism carries the visualizing agent image and speed of the conveying mechanism moves sheet to an optimum value.

### CROSS-REFERENCE TO RELATED APPLICATIONS

This application is based upon and claims the benefit of priority from: U.S. Provisional Application No. 61/326,545 filed on Apr. 21, 2010, the entire contents of each of which are incorporated herein reference.

### FILED

Embodiments described herein relates generally to an image transfer position adjustment and an image forming apparatus using the control.

### BACKGROUND

A toner (a visualizing agent) moves to a sheet medium on the basis of image information and is integrated with the sheet medium. The sheet medium (integrated with the toner) is a hard copy.

In the hard copy, a distance between the leading end of the sheet medium of the hard copy and the leading end of the toner image are different in each machine.

### BRIEF DESCRIPTION OF THE DRAWINGS

A general architecture that implements the various features of the embodiments will now be described with reference to the drawings. The drawings and the associated descriptions are provided to illustrate embodiments and not to limit the scope of the embodiments.

FIG. 1 is an exemplary diagram showing an example of an MFP, according to an embodiment;

FIG. 2 is an exemplary diagram showing an example of an MFP, according to an embodiment;

FIG. 3 is an exemplary diagram showing an example of an MFP, according to an embodiment;

FIG. 4 is an exemplary diagram showing an example of an MFP, according to an embodiment;

FIG. 5 is an exemplary diagram showing an example of an MFP, according to an embodiment; and

FIG. 6 is an exemplary diagram showing an example of an MFP, according to an embodiment.

### DETAILED DESCRIPTION

In general, according to an embodiment, a sheet conveying mechanism comprising: a visualizing agent image carrying mechanism configured to move a visualizing agent image, which moves to a sheet medium, to a moving position to the sheet medium; a media conveying mechanism configured to move the sheet medium to the moving position where the visualizing agent image moves to the sheet medium; a visualizing agent image detector configured to detect the visualizing agent image moved by the visualizing agent image carrying mechanism; a media detector configured to detect passage of the sheet medium to be capable of calculating moving speed of the sheet medium; and a setting unit configured to set, if size of a shift of relative positions of the visualizing agent image and the sheet medium exceeds a tolerance, at least one of speed at which the visualizing agent image carrying mechanism carries the visualizing agent image and speed at which the media conveying mechanism moves the sheet medium to an optimum value.

Embodiments will now be described hereinafter in detail with reference to the accompanying drawings.

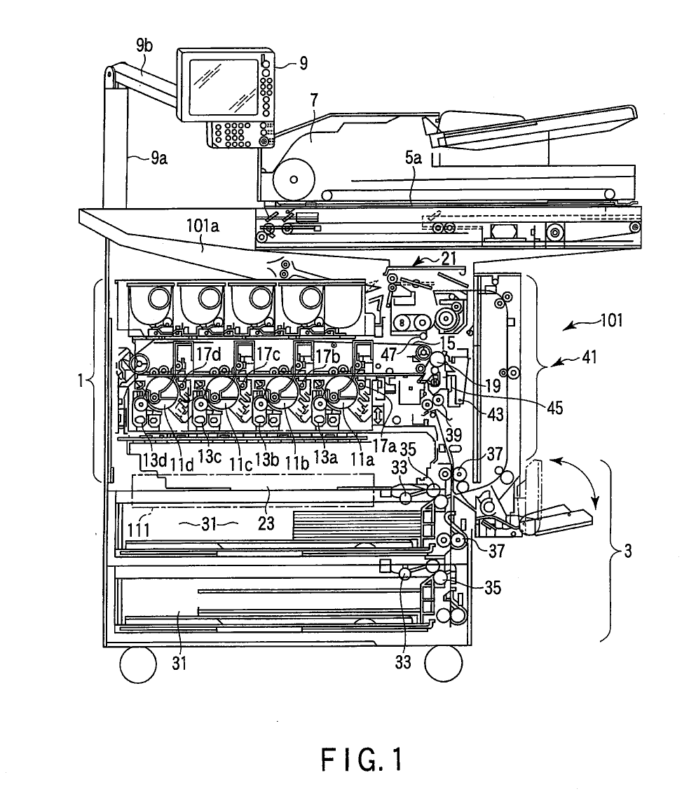

FIG. 1 schematically shows an MFP (Multi-Functional Peripheral) to which the embodiment is able to apply.

An MFP 101 shown in FIG. 1 has an image forming section (a printer section) 1 for outputting image information as an output image which is referred to as a hard copy or a print out, a sheet feeder 3 to supply a sheet medium having an optional size, which is used for an image output, to the image forming section 1, and a scanner section 5 to provide image data of an original to the image forming section 1.

Moreover, the scanner section 5 integrally has an automatically-document feeder (ADF) 7 the original to a reading position on the scanner section 5.

A control panel 9 for giving an instruction for starting image formation in the image forming section 1 and starting to read image information of the original through the scanner section 5 is placed in a strut 9a fixed to the image forming section 1 and a swing arm 9b in a corner at a left or right side behind the scanner section 5.

The image forming section 1 includes first to fourth photoconductive drums 11a to 11d for holding latent images, developers 13a to 13d for supplying a toner to the latent images on the photoconductive drums 11a to 11d to develop toner images, a transfer belt 15 for holding the toner images transferred from the photoconductive drums 11a to 11d in order, cleaners 17a to 17d for cleaning the individual photoconductive drums 11a to 11d, a transfer roller 19 for transferring the toner image held by the transfer belt 15 onto a sheet medium, a fuser 21 for fixing the toner image transferred to the sheet medium by the transfer roller 19 onto the sheet medium, and an exposing device 23 for forming latent images on the photoconductive drums 11a to 11d.

The first to fourth developers 13a to 13d store toners having optional colors of Y (yellow), M (magenta), C (cyan) and Bk (black) which are used for obtaining a color image by a subtractive process and visualize a latent image held by each of the photoconductive drums 11a to 11d in any of the colors Y, M, C and Bk. The respective colors are determined in predetermined order corresponding to an image forming process or a characteristic of the toner.

The transfer belt 15 holds the toner images having the respective colors which are formed by the first to fourth photoconductive drums 11a to 11d and the corresponding developers 13a to 13d in order (of the formation of the toner images).

The sheet feeder 3 supplies the sheet medium to be transferred the toner image by the transfer roller 19.

Cassettes positioned in a plurality of cassette slots 31 store sheet media having optional sizes. Depending on an image forming operation, a pickup roller 33 takes the sheet medium out of the corresponding cassette. The size of the sheet medium corresponds to a size of the toner image formed by the image forming section 1.

A separating mechanism 35 prevents at least two sheet media from being taken out of the cassette by the pickup roller 33.

A plurality of delivery rollers 37 feed the sheet medium separated to be one sheet medium by the separating mechanism 35 toward a registration (an aligning) roller 39.

The registration roller 39 feeds the sheet medium to a transfer position in which the transfer roller 19 and the transfer belt 15 come in contact with each other in a timing for transferring the toner image from the transfer belt 15 by the transfer roller 19.

A front transfer sensor 45 to detect a present or an absent of the sheet medium, if the sheet medium is jammed in the path between the registration roller 39 and an transfer area of the toner from the transfer belt 15 to the sheet medium held by the transfer roller 19. Specifically, the front transfer sensor 45 detects presence or absence of a sheet medium moving to the transfer area (if the sheet medium is present after elapse of a fixed period, a jam of the sheet medium occurs). The front transfer sensor 45 can detect the leading end of the sheet medium when the sheet medium moves.

A post transfer sensor 47 to detect a present or an absent of the sheet medium, if the sheet medium is jammed in the path between the transfer area of the toner from the transfer belt 15 to the sheet medium held by the transfer roller 19 and the fuser 21. Specifically, the post transfer sensor 47 detects presence or absence of a sheet medium moving to a roller included in the fuser 21 (if the sheet medium is present after elapse of a fixed period, a jam of the sheet medium occurs). The post transfer sensor 47 can detect the leading end of the sheet medium when the sheet medium moves.

A position sensor 49 to detect a leading edge of an image formed on the transfer belt 15. An output of the position sensor 49 can be used to determine whether there is a shift between the position of the color image including any one of the colors Y, M, C, and Bk in each of the photoconductive drums 11a to 11d developed with the first to fourth developers 13a to 13d and the position of the color image moving to the sheet medium in the transfer area.

The transfer roller 19 is positioned in an automatically-duplex unit (ADU) 41 for replacing both sides of the sheet medium, that is, the output image (hard copy, print out) which has the toner image fixed thereto by the fuser 21.

The fuser 21 fixes the toner image corresponding to the image information onto the sheet medium as the output image (hard copy, print out) and feeds the output image to a stocker 101a positioned in a space between the scanner section 5 and the image forming section 1.

The ADU 41 moves to a side (a right side) with respect to the image forming section 1, if the sheet medium is jammed between the delivery roller 37 (a final one) and the registration roller 39 or between the registration roller 39 and the fuser 21, that is, in the transfer roller 19 or the fuser 21. The ADU 41 integrally has a cleaner 25 for cleaning the transfer roller 19.

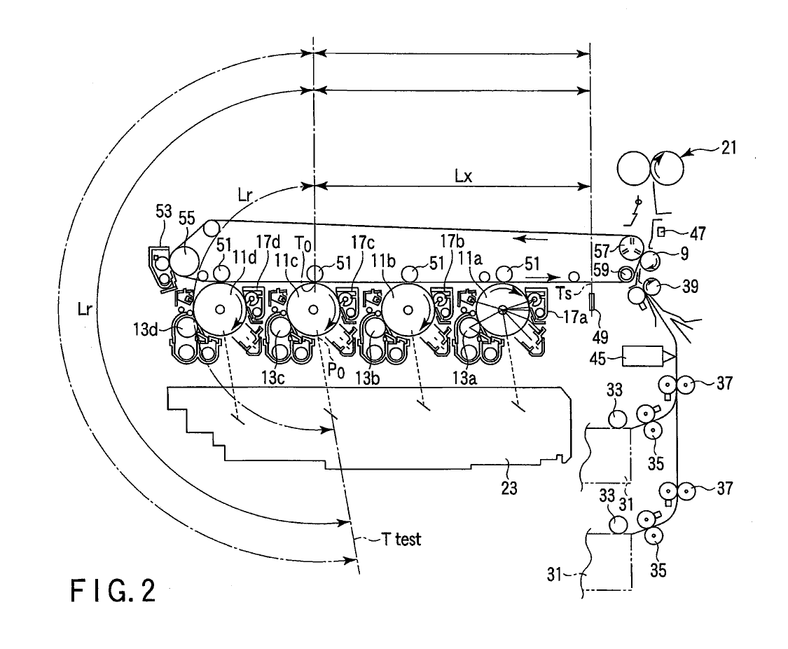

FIG. 2 shows a transfer section and an exposing position of an image forming section in the MFP shown in FIG. 1.

A bend of a belt surface of the transfer belt 15 is a fixed amount related to tension from at least one tension device. The belt opposed member 51, the belt cleaner opposed member 55, and the transfer opposed member 57 are, for example, roller members. The belt opposed member 51 provides the transfer belt 15 and the photoconductive drums 11a to 11d with a transfer voltage (an electrostatic field). The belt cleaner 53 eliminates toner remained on the transfer belt 15. At least one of roller members the belt cleaner opposed member 55, the transfer opposed member 57 and roller member 59 is driven with a motor (belt motor or maim motor). The transfer roller 19 applies, when the sheet material moves between the transfer roller 19 and the transfer belt 15, pressure for transfer to the sheet material (and the transfer belt 15). The transfer roller 19 provides the sheet material (and the transfer belt 15) with a transfer voltage (an electrostatic field).

The exposing device 23 exposes the drums 11a to 11d with lights, each corresponds the any of the colors

Y, M, C and Bk.

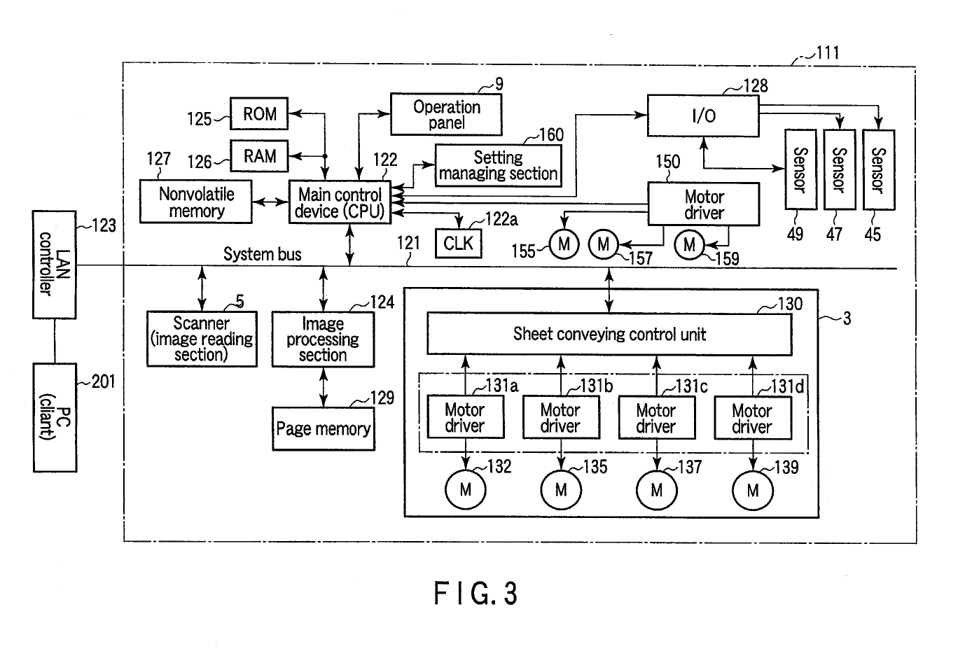

As indicated by an example shown in FIG. 3, a control unit 111 includes a system bus 121.

The system bus 121 is connected to a main control block configured to process an output of a copy of an original document by the image forming section 1, i.e., a main control block (a CPU) 122. A clock section (CLK) 122a is connected to the CPU 122. The CLK (clock section) 122a may be firmware of the CPU (the main control block) 122.

The CPU 122 is connected to the scanner section 5, the ADF 7, and an operation unit 9. The control unit 111 also includes an image processing section 124 connected to the CPU 122 via the system bus 121 and configured to apply image processing, which is requested by the image forming section 1 to form an output image, to image data input from the scanner section 5, a client (PC (Personal Computer)) 201 connected through a LAN (Local Area Network) controller 123, or the like.

The CPU 122 is also connected to a ROM (Read Only Memory) 125, a RAM (Random Access Memory) 126, and a nonvolatile memory 127 configured to store a total number of times of image formation, a total operation time, and the like.

The CPU 122 acquires, on the basis of an output of the front transfer sensor 45 connected to an I/O (input output port/interface) 128, passing time of the sheet medium moving to the transfer area. The CPU 122 monitors an output of the post transfer sensor 47 and acquires passing time of the sheet medium moving to the fuser 21. Further, the CPU 122 acquires, on the basis of an output of the position sensor 49, the position of the color image including any one of the colors Y, M, C, and Bk in each of the photoconductive drums 11a to 11d developed with the first to fourth developers 13a to 13d and passing time of the color image moving to the sheet medium in the transfer area.

The CPU 122 sets, in a motor driver 150, the number of revolutions of any one of the rollers 55 (or 57 or 59) rotated by a motor 155 and sets the moving speed of the transfer belt 15. For example, the photoconductive drums 11a to 11d receive rotation of the motor 155 through a gear train and rotate at predetermined speed. The CPU 122 sets, in the motor driver 150, the number of revolutions of the roller in the fuser 21 rotated by a motor 157 (the moving speed of the roller surface) and the number of revolutions of the transfer roller 19 rotated by the motor 157 (the moving speed of the roller surface) to predetermined speed.

The CPU 122 is also connected to a sheet conveyance control unit 130 in the sheet feeder 3 connected through the system bus 121. The CPU 122 controls operation timing of a motor driver 131a for driving a pickup motor 133 configured to rotate the pickup roller 33, which picks up the sheet media having a size corresponding to the size of an output image from each of the cassettes 31, at predetermined timing, a motor driver 131b for driving a separation motor 135 configured to rotate a roller included in the separating mechanism 35, a motor driver 131c for driving a delivery roller motor 137 configured to rotate rollers included in the delivery rollers 37, a motor driver 131d for driving an registration roller motor 139 configured to rotate the registration roller 39, and the like. The motor drivers 131a, 131b, 131c, and 131d may be integrated.

The image forming section 124 generates output data corresponding to an output image (output image data) on a map of a page memory 129 connected to the image processing section 124.

According to exposure data, i.e., Y (yellow), M (magenta), C (cyan), and Bk (black) prepared to correspond to the output image on the map of the page memory 129, the exposing device 23 forms latent images on the respective photoconductive drums 11a to 11d.

A setting managing section 160 calculates, according to, for example, time when the position sensor 49 detects a test pattern image used for calculating the passing time (elapsed period) shown in

FIG. 2, i.e., a toner image formed by any one of the drums 11a, 11b, 11c, and 11d and developed by the developing devices 13a to 13d having a toner of a corresponding color and, for example, timing when the post transfer sensor 47 detects passage (entrance) of the sheet medium, how long time the passing time shifts compared with a scheduled time (hour) when the image for output (printout) moving on the transfer belt 15 moves to the sheet medium in the transfer area (how long is the difference between the passing time and the scheduled time).

For the calculation, moving speed “V” of the belt surface of the transfer belt 15 is used. Specifically, the moving speed “V” of the belt surface of the transfer belt 15 can be calculated as

V=(Lr+Lx)/Ttest

by dividing, by an elapsed period Ttest from exposure start to time Ts when the toner image (the test pattern image) passes the position sensor 49, a distance obtained by adding a distance Lr [r is the radius of the drum] from the exposing position P0 to the transfer position T0 where the transfer belt 15 and the drum come into contact with each other through the development of the test pattern image in FIG. 2 and a distance Lx [x is different depending on the drum that bears the test pattern image] from the transfer position T0 to the detection position T1 where the position sensor 49 detects the test pattern image. In some case, an output of the position sensor 49 includes a difference (a space d) between the leading edge of the sheet medium, which could include input image data, and the test pattern image. In that case, the distance only has to be set to

Lr+Lx+Ld

to compensate for the influence of the space d.

The calculated difference (shift) indicates a shift of the position of the image for output (printout) moving to the sheet medium from the leading end position of the sheet medium set in advance.

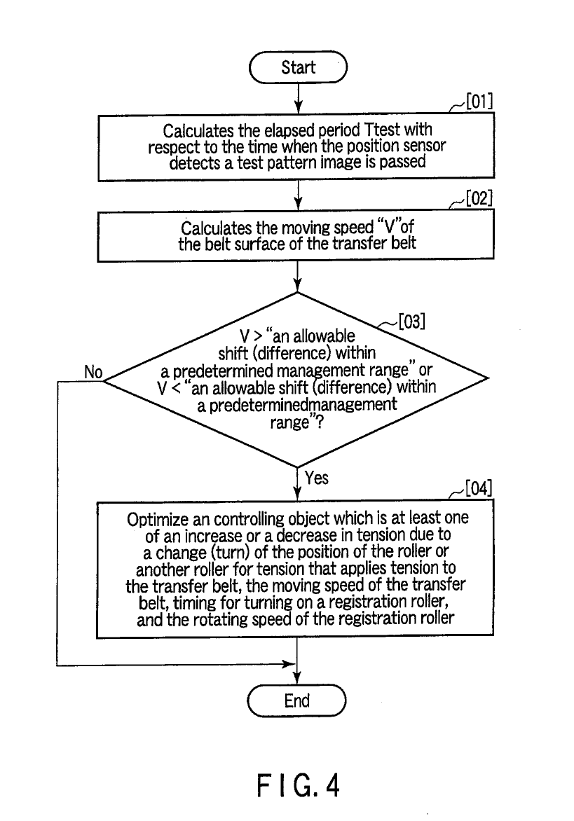

In detail, the setting managing section 160, shown in FIG. 4, calculates the elapsed period Ttest with respect to the time when the position sensor 49 detects a test pattern image is passed [01], and calculates the moving speed “V” of the belt surface of the transfer belt 15 [02].

In a case when, determine “V” >“an allowable shift (difference) within a predetermined management range” [03].

If, the moving speed “V” is lager than an allowable shift (difference) within a predetermined management range [03-YES], to optimize an controlling object which is at least one of an increase or a decrease in tension due to a change (turn) of the position of the roller (55, 57, or 59 or another roller for tension) that applies tension to the transfer belt 15, the moving speed of the transfer belt 15, timing for turning on a registration roller, and the rotating speed of the registration roller [04].

Therefore, if the calculated shift is larger than the allowable shift (difference), to keep the size of the shift within predetermined management range, for example,
timing for turning on the registration roller 39 is adjusted,
the rotating speed of the registration roller 39 is adjusted,
the number of revolutions of any one of the rollers 55 (or 57 or 59) rotated by the motor 155 to set the moving speed of the transfer belt 15 are optimized such that the allowable shift (difference) is kept within the predetermined management range, or, according to, for example,
an increase or a decrease in tension due to a change (turn) of the position of the roller (55, 57, or 59 or another roller for tension) that applies tension to the transfer belt 15, the moving speed of the transfer belt 15 is optimized such that the allowable shift (difference) is kept within the predetermined management range. In this way, the shift can be kept within the range of the predetermined size. In other words, the influence on an image due to the shift can be reduced (eliminated). Therefore, the quality of the image for output (printout) can be maintained.

The moving speed “V” of the belt surface of the transfer belt 15 can be calculated as

V=Lt/Ttest

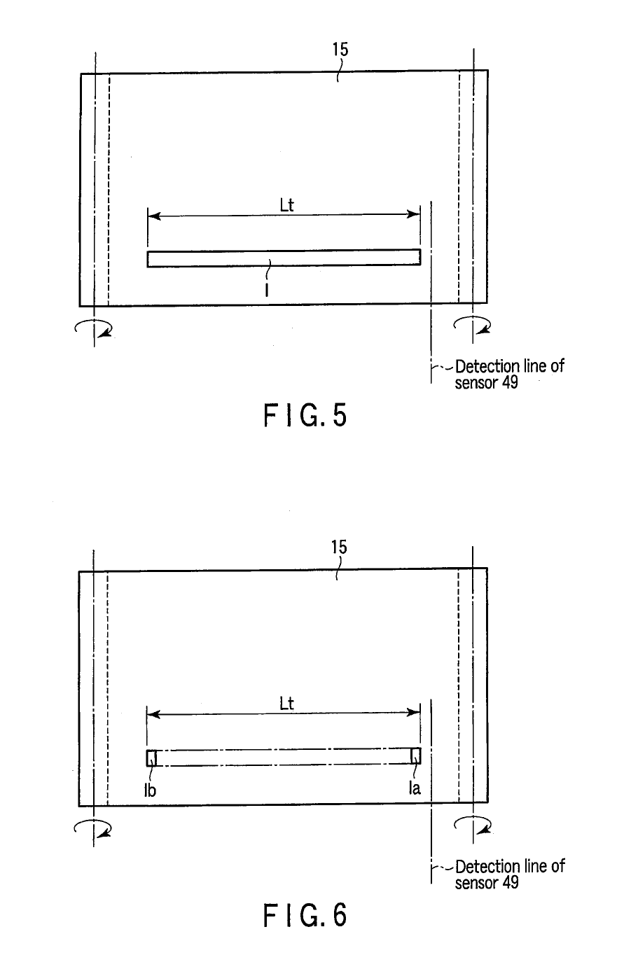

by, for example, as shown in FIG. 5, preparing a test pattern image “I” having fixed length (Lt) moving on the transfer belt 15, calculating a passing period Ttest from the leading end and the trailing end of the test pattern image detected by the position sensor 49, and dividing the passing period Ttest by the length Lt.

Since the passing period Lt only has to be able to be calculated, it is also possible to prepare, as shown in FIG. 6, the test pattern image Ia having fixed length on the leading end side and the test pattern image Ib having fixed length on the trailing end side as the test pattern image “I” having the fixed length Lt and set a distance between the leading end of the test pattern image Ia and the trailing end of the test pattern image Ib detected by the position sensor 49 as Lt.

The creation of the test pattern image and the calculation of the moving speed of the test pattern image moved by the movement of the transfer belt 15 (i.e., the moving speed of the transfer belt 15),
the calculation of the (actual) moving speed of the sheet medium,
the comparison of the calculations (two calculation results), and
the optimization of at least one of the moving speed (movement start timing) of the sheet medium and the moving speed of the transfer belt 15, which are explained above with reference to FIG. 2, FIG. 4, FIG. 5, or FIG. 6 can be automatically processed by the controller 111 if [start instruction] to the setting managing section 160 is made. A result of the optimization, i.e., a setting value (the number of pulses) or the like in the motor driver 150 for setting the number of revolutions of the motor 155, which controls the moving speed of the transfer belt 15, is desirably stored in, for example, the nonvolatile memory 127 until the next setting is performed (the setting is updated).

The automatic processing explained above is carried out every time, for example, a power supply for the MFP 101 is turned on (the MFP 101 is started). The start of the automatic processing can be set at arbitrary timing by the user, for example, timing of display of [adjustment mode] displayed on the operation panel 9. In such a case, for example, if the user determines that the leading end position of an image fluctuates because of the influence of, for example, wear of the roller that rotates the transfer belt 15 for moving the image, a space (relative positions) of the leading end position of the image and the leading end of the sheet medium can be automatically aligned (optimized) by printing one pattern for adjustment (executing the [adjustment mode]).

In this way, with timing for turning on an exposure timing sensor (the position sensor 49) or the registration roller 39 (when a predetermined time elapses after the front transfer sensor 45 passes) or the like set as a trigger, using time when a twining sensor (the post transfer sensor 47) set between the registration roller 39 and the fuser 21 detects passage of the sheet medium, a shift between a scheduled time when the image for output (printout) moved by the movement of the transfer belt 15 moves to the sheet medium in the transfer area and a design value of speed of the movement of the sheet medium is calculated. Consequently, the leading end position of the image can be automatically adjusted by adjusting the timing of the sheet medium and the timing of the image (adjusting the timings such that the size of the shift is kept within the allowable range), for example,
adjusting timing for turning on a registration roller (the registration roller),
adjusting the rotating speed of the registration roller (the registration roller),
optimizing the number of revolutions of any one of the rollers 55 (or 57 or 59) rotated by the motor 155 to set the moving speed of the transfer belt 15 such that the allowable shift (difference) is kept within the predetermined management range, or, according to, for example,
an increase or a decrease in tension due to a change (turn) of the position of the roller (55, 57, or 59 or another roller for tension) that applies tension to the transfer belt 15, optimizing the moving speed of the transfer belt 15 such that the allowable shift is kept within the predetermined management range (automatically adjusting the rotating speed of the driving roller of the transfer belt unit (TBU) and/or the moving speed of the transfer belt 15). In other words, the shift can be kept within the range of the predetermined size. Consequently, the influence on the image due to the shift can be reduced (eliminated). Therefore, the quality of the image for output (printout) can be maintained.

When the number of revolutions of any one of the rollers 55 (or 57 or 59) rotated by the motor 155 (using the motor driver 150) is set such that the allowable shift (difference) is kept within the predetermined management range, if only the moving speed of the transfer belt 15 (actually, in most cases, the photoconductive drums 11a to 11d receive power from a motor same as the motor for the transfer belt 15) is changed, in some case, a shift (a speed difference) between the moving speed and the number of revolutions of the roller in the fuser 21 exceeds a tolerance. Therefore, it is more desirable that, when necessary, the CPU 122 (the setting managing section 160) sets,
in the motor driver 150,
the number of revolutions of the roller in the fuser 21 rotated by the motor 157 (the moving speed of the roller surface) and
the number of revolutions of the transfer roller 19 rotated by the motor 159 (the moving speed of the roller surface) to be predetermined speed.

In this way, with timing for turning on the exposure timing sensor (the position sensor 49) or the registration roller 39 (when a predetermined time elapses after the front transfer sensor 45 passes) or the like set as a trigger, using time when the twining sensor (the post transfer sensor 47) set between the registration roller 39 and the fuser 21 detects passage of the sheet medium, a shift between a scheduled time when the image for output (printout) moved by the movement of the transfer belt 15 moves to the sheet medium in the transfer area and a design value of speed of the movement of the sheet medium is calculated. Consequently, a space (relative positions) of the leading end position of the image and the leading end of the sheet medium can be automatically aligned (optimized) by adjusting the timing of the sheet medium and the timing of the image (adjusting the timings such that the size of the shift is kept within the allowable range), for example,
adjusting timing for turning on the registration roller (the registration roller), and
adjusting the rotating speed of the registration roller (the registration roller), or optimizing the number of revolutions of any one of the rollers 55 (or 57 or 59) rotated by the motor 155 to set the moving speed of the transfer belt 15 such that the allowable shift (difference) is kept within the predetermined management range, (automatically adjusting the rotating speed of the driving roller of the TBU (transfer belt unit) and/or the moving speed of the transfer belt 15).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sheet conveying mechanism comprising:
a visualizing agent image carrying mechanism configured to move a visualizing agent image, which moves to a sheet medium, to a moving position to the sheet medium;
a media conveying mechanism configured to move the sheet medium to the moving position where the visualizing agent image moves to the sheet medium;
a visualizing agent image detector configured to detect the visualizing agent image moved by the visualizing agent image carrying mechanism;
a media detector configured to detect passage of the sheet medium to be capable of calculating moving speed of the sheet medium; and
a setting unit configured to set, if size of a shift of relative positions of the visualizing agent image and the sheet medium exceeds a tolerance, at least one of speed at which the visualizing agent image carrying mechanism carries the visualizing agent image and speed at which the media conveying mechanism moves the sheet medium to an optimum value.

2. The mechanism of claim 1, wherein the setting unit detects, on the basis of a difference between a period between a point when the visualizing agent image detector detects the visualizing agent image and an output point of an image signal corresponding to the visualizing agent image and a period between the output point of the image signal corresponding to the visualizing agent image and a predicted point when the visualizing agent image should be detected by the visualizing agent image detector, the speed at which the visualizing agent image carrying mechanism moves the visualizing agent image and sets at least one of the speed at which the visualizing agent image carrying mechanism moves the visualizing agent image and the speed at which the media conveying mechanism moves the sheet medium to the optimum value.

3. The mechanism of claim 1, wherein the setting unit calculates length of the visualizing agent image from a leading end and a trailing end of the visualizing agent image detected by the visualizing agent image detector, detects, on the basis of a difference between the length and an output period of the image signal, the speed at which the visualizing agent image carrying mechanism moves the visualizing agent image, and sets at least one of the speed at which the visualizing agent image carrying mechanism moves the visualizing agent image and the speed at which the media conveying mechanism moves the sheet medium to the optimum value.

4. The mechanism of claim 2, wherein the setting unit detects, on the basis of the difference between the period between the point when the visualizing agent image detector detects the visualizing agent image and the output point of the image signal corresponding to the visualizing agent image and the period between the output point of the image signal corresponding to the visualizing agent image and the predicted point when the visualizing agent image should be detected by the visualizing agent image detector, the speed at which the visualizing agent image carrying mechanism moves the visualizing agent image and sets timing when the media conveying mechanism starts the movement of the sheet medium to an optimum value.

5. The mechanism of claim 3, wherein the setting unit detects, on the basis of a difference between a period between a point when the visualizing agent image detector detects the visualizing agent image and an output point of an image signal corresponding to the visualizing agent image and a period between the output point of the image signal corresponding to the visualizing agent image and a predicted point when the visualizing agent image should be detected by the visualizing agent image detector, the speed at which the visualizing agent image carrying mechanism moves the visualizing agent image and sets timing when the media conveying mechanism starts the movement of the sheet medium to an optimum value.

6. The mechanism of claim 2, wherein the setting unit detects, on the basis of the difference between the period between the point when the visualizing agent image detector detects the visualizing agent image and the output point of the image signal corresponding to the visualizing agent image and the period between the output point of the image signal corresponding to the visualizing agent image and the predicted point when the visualizing agent image should be detected by the visualizing agent image detector, the speed at which the visualizing agent image carrying mechanism moves the visualizing agent image and sets speed at which the media conveying mechanism moves the sheet medium to an optimum value.

7. The mechanism of claim 3, wherein the setting unit detects, on the basis of a difference between a period between a point when the visualizing agent image detector detects the visualizing agent image and an output point of an image signal corresponding to the visualizing agent image and a period between the output point of the image signal corresponding to the visualizing agent image and a predicted point when the visualizing agent image should be detected by the visualizing agent image detector, the speed at which the visualizing agent image carrying mechanism moves the visualizing agent image and sets speed at which the media conveying mechanism moves the sheet medium to an optimum value.

8. The mechanism of claim 2, wherein the setting unit detects, on the basis of the difference between the period between the point when the visualizing agent image detector detects the visualizing agent image and the output point of the image signal corresponding to the visualizing agent image and the period between the output point of the image signal corresponding to the visualizing agent image and the predicted point when the visualizing agent image should be detected by the visualizing agent image detector, the speed at which the visualizing agent image carrying mechanism moves the visualizing agent image and sets speed at which the visualizing agent image carrying mechanism moves the visualizing agent image to an optimum value.

9. The mechanism of claim 3, wherein the setting unit detects, on the basis of a difference between a period between a point when the visualizing agent image detector detects the visualizing agent image and an output point of an image signal corresponding to the visualizing agent image and a period between the output point of the image signal corresponding to the visualizing agent image and a predicted point when the visualizing agent image should be detected by the visualizing agent image detector, the speed at which the visualizing agent image carrying mechanism moves the visualizing agent image and sets speed at which the visualizing agent image carrying mechanism moves the visualizing agent image to an optimum value.

10. A sheet conveying method comprising:
calculating moving speed of a moving visualizing agent image;
calculating a difference between the moving speed of the visualizing agent image and reference speed;
calculating moving speed of a moving sheet medium; and
setting, if size of a shift of relative positions of the visualizing agent image and the sheet medium exceeds a tolerance, at least one of the moving speed of the visualizing agent image and the moving speed of the sheet medium to an optimum value.

11. The method of claim 10, wherein, if the size of the shift of the relative positions of the visualizing agent image and the sheet medium exceeds the tolerance, timing when the movement of the sheet medium is started is set to an optimum value.

12. The method of claim 10, wherein, if the size of the shift of the relative positions of the visualizing agent image and the sheet medium exceeds the tolerance, speed at which the sheet medium is moved is set to an optimum value.

13. The method of claim 10, wherein, if the size of the shift of the relative positions of the visualizing agent image and the sheet medium exceeds the tolerance, speed at which the visualizing agent image is moved is set to an optimum value.

14. An image forming apparatus comprising:
a transfer device configured to transfer an image formed of a visualizing agent onto a sheet medium;
an image carrying mechanism configured to move the image formed of the visualizing agent such that the transfer device can move the image onto the sheet medium;
a media conveying mechanism configured to move the sheet medium to a transfer position of the transfer device where the image formed of the visualizing agent moves onto the sheet medium;
a visualizing agent image detector configured to detect the image formed of the visualizing agent moved by the image carrying mechanism;
a media detector configured to detect passage of the sheet medium to be capable of calculating moving speed of the sheet medium; and
a controller configured to set, if size of a shift of relative positions of the image formed of the visualizing agent and the sheet medium exceeds a tolerance, at least one of speed at which the image carrying mechanism carries the image formed of the visualizing agent and speed at which the media conveying mechanism moves the sheet medium to an optimum value.

15. The apparatus of claim 14, wherein the controller detects, on the basis of a difference between a period between a point when the visualizing agent image detector detects the image formed of the visualizing agent and an output point of an image signal corresponding to the image formed of the visualizing agent and a period between the output point of the image signal corresponding to the image formed of the visualizing agent and a predicted point when the image formed of the visualizing agent should be detected by the visualizing agent image detector, the speed at which the image carrying mechanism moves the image formed of the visualizing agent and sets at least one of the speed at which the image carrying mechanism moves the image formed of the visualizing agent and the speed at which the media conveying mechanism moves the sheet medium to the optimum value.

16. The apparatus of claim 14, wherein the controller calculates length of the image formed of the visualizing agent from a leading end and a trailing end of the image formed of the visualizing agent detected by the visualizing agent image detector, detects, on the basis of a difference between the length and an output period of the image signal, the speed at which the image carrying mechanism moves the image formed of the visualizing agent, and sets at least one of the speed at which the image carrying mechanism moves the image formed of the visualizing agent and the speed at which the media conveying mechanism moves the sheet medium to the optimum value.

17. The apparatus of claim 15, wherein the controller detects, on the basis of the difference between the period between the point when the visualizing agent image detector detects the image formed of the visualizing agent and the output point of the image signal corresponding to the image formed of the visualizing agent and the period between the output point of the image signal corresponding to the image formed of the visualizing agent and the predicted point when the image formed of the visualizing agent should be detected by the visualizing agent image detector, the speed at which the image carrying mechanism moves the image formed of the visualizing agent and sets timing when the media conveying mechanism starts the movement of the sheet medium to an optimum value.

18. The apparatus of claim 16, wherein the controller detects, on the basis of a difference between a period between a point when the visualizing agent image detector detects the image formed of the visualizing agent and an output point of an image signal corresponding to the image formed of the visualizing agent and a period between the output point of the image signal corresponding to the image formed of the visualizing agent and a predicted point when the image formed of the visualizing agent should be detected by the visualizing agent image detector, the speed at which the image carrying mechanism moves the image formed of the visualizing agent and sets timing when the media conveying mechanism starts the movement of the sheet medium to an optimum value.

19. The apparatus of claim 15, wherein the controller detects, on the basis of the difference between the period between the point when the visualizing agent image detector detects the image formed of the visualizing agent and the output point of the image signal corresponding to the image formed of the visualizing agent and the period between the output point of the image signal corresponding to the image formed of the visualizing agent and the predicted point when the image formed of the visualizing agent should be detected by the visualizing agent image detector, the speed at which the image carrying mechanism moves the image formed of the visualizing agent and sets speed at which the media conveying mechanism moves the sheet medium to an optimum value.

20. The apparatus of claim 16, wherein the controller detects, on the basis of a difference between a period between a point when the visualizing agent image detector detects the image formed of the visualizing agent and an output point of an image signal corresponding to the image formed of the visualizing agent and a period between the output point of the image signal corresponding to the image formed of the visualizing agent and a predicted point when the image formed of the visualizing agent should be detected by the visualizing agent image detector, the speed at which the image carrying mechanism moves the image formed of the visualizing agent and sets speed at which the media conveying mechanism moves the sheet medium to an optimum value.

21. The apparatus of claim 15, wherein the controller detects, on the basis of the difference between the period between the point when the visualizing agent image detector detects the image formed of the visualizing agent and the output point of the image signal corresponding to the image formed of the visualizing agent and the period between the output point of the image signal corresponding to the image formed of the visualizing agent and the predicted point when the image formed of the visualizing agent should be detected by the visualizing agent image detector, the speed at which the image carrying mechanism moves the image formed of the visualizing agent and sets speed at which the image carrying mechanism moves the image formed of the visualizing agent to an optimum value.

22. The apparatus of claim 16, wherein the controller detects, on the basis of a difference between a period between a point when the visualizing agent image detector detects the image formed of the visualizing agent and an output point of an image signal corresponding to the image formed of the visualizing agent and a period between the output point of the image signal corresponding to the image formed of the visualizing agent and a predicted point when the image formed of the visualizing agent should be detected by the visualizing agent image detector, the speed at which the image carrying mechanism moves the image formed of the visualizing agent and sets speed at which the image carrying mechanism moves the image formed of the visualizing agent to an optimum value.
